(19) United States
(12) Patent Application Publication
(10) Pub. No.: US 2004/0015411 A1
(43) Pub. Date: Jan. 22, 2004

(54) System and method for trading of electronic valuable documents

(76) Inventors: Michael Hedman, Sundbyberg (SE); Simon Falk, Stockholm (SE); Claes Kjellman, Solna (SE); Patrik Wahlstrom, Solna (SE)

Correspondence Address: NIXON & VANDERHYE, PC, 1100 N GLEBE ROAD, 8TH FLOOR, ARLINGTON, VA, 22201-4714, US

(21) Appl. No.: 10/343,681

(22) PCT Filed: Aug. 3, 2001
(86) PCT No.: PCT/SE01/01704

(30) Foreign Application Priority Data
Aug. 3, 2000 (SE) 0002811-8

(51) Int. Cl. G06F 17/60

(52) U.S. Cl. 705/26

(57) ABSTRACT

The present invention relates to a trade system for automated transfer of valuable documents between a user and a vendor, in particular relating to user activities and/or reservations. Transfer of documents within the system are performed bi-directionally between a user interface (10) and a responding external booking unit (20) of the system. The system comprises a distribution server (40), adapted to dis-tribute documents from the vendor to users of the system and a payment service (30) for administration of payments for transferred documents. Both the server (40) and the payment service (30) associated with the booking unit (20) and a communication terminal (50) is adapted for communication with the distribution server (40) by means of a message carrier means. Moreover the system comprises a persistent memory (1, 2, 3) accessible from the booking unit (20), and the distribution server (40), is arranged for storage of data relating to the transfer of documents. Output means (90) displays the different stages of operation of the system and validation unit (80) is arranged between the communication terminal (50) and the output de-vice for controlling and validating the transferred documents so as to obtain auto-mated trading for enhanced security and cost effectiveness.

### TECHNICAL FIELD

The present invention relates to secure trading of electronic valuable documents, and more specific, to a system and method in particular adopted for distribution and validation of electronic valuable documents.

### BACKGROUND OF THE INVENTION

For many years, all trading of documents representing a limited, but yet a certain value, such as tickets for transportation, reservations for events and coupons, has been carried out manually. Personnel have been required at each stage of the trading, which in many cases have been rather inconvenient, but also tedious and expensive. Manual service is often expensive since each person involved in the trade is to be paid.

However, several attempts have been made since the completely manual treatment. Methods for handling and trading of documents representing values have improved a lot. A few examples are the ordering of a ticket for a movie or a train by telephone. The person who orders is given an individual code, by which the ordered valuable document, no matter if it is a train or movie ticket is made accessible, when reaching the service centre or ticket counter. Valuable documents, such as the mentioned tickets or coupons can even be sent to people by mail, provided the order is made a few days in advance.

All these services require long-term planning or mobility of the person who orders and usage is therefore limited both in sparsely populated and remotely located regions. There is an increasing need of mobile solutions relating to a spectrum of services in our every day life. Prior art concerning distribution and payment solutions of cinema tickets discloses work by P. Sirvib, Mobile Electronic Commerce, Royal Institute of Technology, Sweden, Business Development and Media Technology, Master degree thesis, 2000.

The thesis introduces mobile electronic ticketing as a vision. Obvious advantages with electronic ticketing are mentioned, such that electronic ticketing eliminates the paper ticket while simultaneously improving the distribution and logistics. However, a fully operational solution ready for industrial implementation is not at all presented.

### SUMMARY OF THE INVENTION

It is an object of the present invention to provide a system and method which rationalises the trade of value documents by eliminating the handling of paper, and thereby totally automates the flow of value documents.

This object is attained by means of trade system and method for automated transfer of valuable documents between a user and a vendor, in particular relating to user activities and/or reservations, the transfer of documents being performed bi-directionally between a user interface and a responding external booking unit of the system, the system further comprising:

a distribution server adapted to distribute documents from the vendor to users of the system, and a payment service for administration of payments for transferred documents, both the server and the service associated with the booking unit;

a communication terminal being adapted in particular for communication with the distribution server by means of anyone of current message carrier means;

at least one persistent memory, accessible from the booking unit, and the distribution server, is arranged for storage of data relating to the transfer of documents;

output means which displays the different stages of operation of the system;

characterised in that

a validation unit being arranged between the communication terminal and the output device for controlling and validating the transferred documents so as to obtain automated trading for enhanced security and cost effectiveness.

As mentioned earlier, it is a fact that there exists no such system or method, which both distributes and validates valuable documents, and actually handles the value document and not only a representation, such as a booking confirmation, or a control or reference number. No other systems known to the best of our knowledge provide a totally automated way of handling valuable documents of this kind.

Further, if the user has a valuable document, by chance in electronic format instead of merely a booking confirmation, the reservation or ticket is easily accessible in for instance a communication terminal. This gives the user a sense of reliability and at the same time simplifies or makes checking and/or updating of data possible.

It is also an object of the present invention to provide a system and method for both time and cost effective trading of valuable documents. Employing the prior art methods. i.e. using booking confirmation, or similar methods, often demands manual validation and is therefore slower and tedious. As mentioned earlier, as an effect of the automatic validation, personnel reductions may be possible. Tasks of the personnel still required for the service will be both more qualified and interesting. Obviously, the present invention generates multiple benefits in comparison with already existing systems and methods; it simplifies the trading procedure and makes it more accessible by letting the user be mobile; the user is not compelled to visit locations where documents are made available, eventually one or several times in advance of the actual event.

Moreover, the present invention simplifies cancellations and changes of bookings; the faster, automatic validation results in reduced lines, and thus, smoother and faster entrance to events. Used properly, it will be easier to have arena events filled to their whole capacities, due to the advantageous method practised in the present invention, since users in a simple way can book and receive value documents in advance, and the organisers of the event can plan ahead. Last but not at all least, mentioned benefits hopefully result in lower prices for the end customers, which is beneficial for all of us.

Further, handling electronic value documents this way reduces the handling with cash, credit cards, checks and so on whereby many risks for theft, etc, are alleviated or even avoided.

It is another object of the invention to provide a system and method for a more secure trading of valuable documents. First of all, according to the preferred embodiment, the value documents distributed, in accordance with the present invention, has at least one applied mechanism, such as digital signature, see detailed description of FIG. 2.

Secondly, validation is performed for each and every value document in the validation phase, in contrast to some present system, such as at a movie theatre entrance for example, where the actual validity of the ticket often is not established, even though there are several existing methods to approve the accuracy of tickets, and some other value documents, such as for instance magnetic stripes, ultraviolet radiation of holograms and barcodes.

Further another object of the invention is to provide a system and method for distribution of static or dynamical electronic valuable documents, such as coupons, in a totally automatic system. Systems at present day, in which coupons often takes many turns before they actually may be used, and when used, the manual handling is a known time consuming activity, are clearly ineffective compared with the present invention.

Additional objects, advantages and novel features of the present invention will become apparent to those skilled in the art from the following details, as well as by practice of the invention. While the invention is described below with reference to a plurality of preferred embodiments, it should be understood that the invention is not limited to these. The above mentioned skilled persons having access to the teachings herein will recognise additional applications, modifications and embodiments in other fields which are within the scope of the invention.

### BRIEF DESCRIPTION OF THE DRAWINGS

For a more complete understanding of the present invention and further objects and advantages thereof, reference is now made to the following description of examples of embodiments thereof—as shown in the accompanying drawings, in which:

FIG. 1 illustrates a schematic survey of a trading system of valuable documents in accordance with the present invention.

FIG. 2 illustrates a flowchart representing the method of a distribution server 40 in accordance with the present invention.

FIG. 3 illustrates a schematic survey of a first embodiment of a validation host 70 in accordance with the present invention.

FIG. 4 illustrates a schematic survey of a second embodiment of a validation host 70 in accordance with the present invention.

FIG. 5 illustrates a schematic survey of a third embodiment of a validation host 70, e.g. a combination of the first and the second embodiment, in accordance with the present invention.

FIG. 6 illustrates a schematic survey of a sixth embodiment of a validation host 70, e.g. a combination of a fourth and a fifth embodiment, in accordance with the present invention.

FIG. 7 illustrates a schematic survey of a trading system of value documents, representing a seventh embodiment, in accordance with the present invention.

### DETAILED DESCRIPTION OF THE DRAWINGS

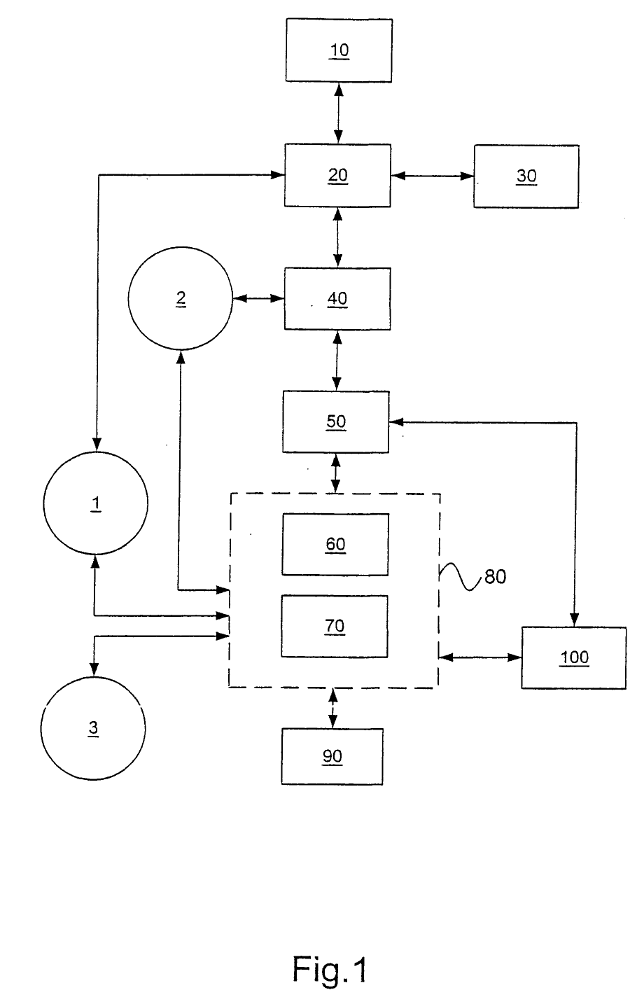

FIG. 1 shows the general structure of a trading system of valuable documents which consists of a user interface 10 that communicates with a booking unit 20. The user interface consists of either a WAP-browser (Wireless Application Protocol), Web-browser, computer telephone integration (CTI), call-centre, CRM-system (Customer Relation Management), or other.

The booking system 20 works toward a payment service 30, and is furthermore connected to a first database I (a booking system database), and interacts also with a distribution server 40.

The distribution server 40 manages the communication between a communication terminal 50, which may be a mobile communication terminal or other, via a network media, e.g. a telecom network or the Internet, using SMS, MMS, e-mail or other as a carrier. The distribution server 40 is further connected to a second database 2 (a distribution server database), and may in a number of embodiments furthermore communicate with a client 100. The distribution server 40 distributes, for example, electronic valuable documents to the communication terminal 50, which documents may be a ticket, a valid coupon of a certain determined or a dynamical value, a transportation ticket, an authorisation to mention a few feasible examples.

Further, the communication terminal 50 is adapted to communicate with a validation unit 80 and the client 100, using for example infrared technology (IR) or radio frequency (RF) technology, e.g. Bluetooth. The validation unit 80 comprises a hardware module 60, for example a PC, hand held device, or other, and software which from now on is referred to as validation host 70. The client 100 comprises a port manager. The validation unit 80 is connected to at least on of the first database 1, the second database 2 and a third database 3 (a local database). The validation unit 80 is also communicating with output means 90, such as GUI, printers, monitors, turnstiles, touch screens, or other, and in a number of embodiments, also with the client 100.

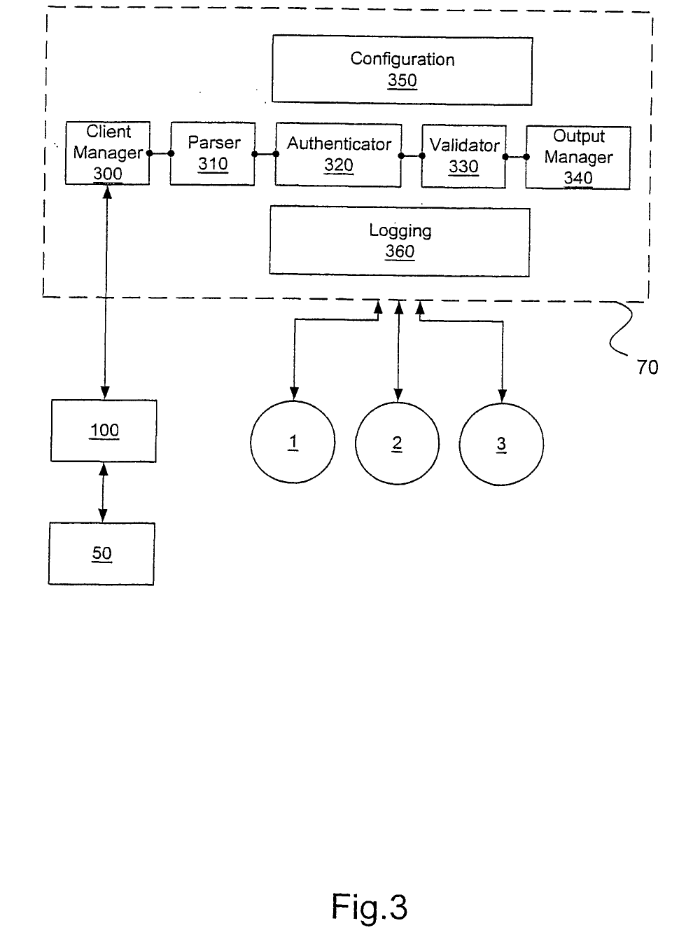

A first embodiment of the present invention comprises a system as showed in FIG. 1, wherein the validation host 70 comprises a client manager 300, as showed in FIG. 3. Further descriptions are to be found below with reference to a functional description of FIG. 3.

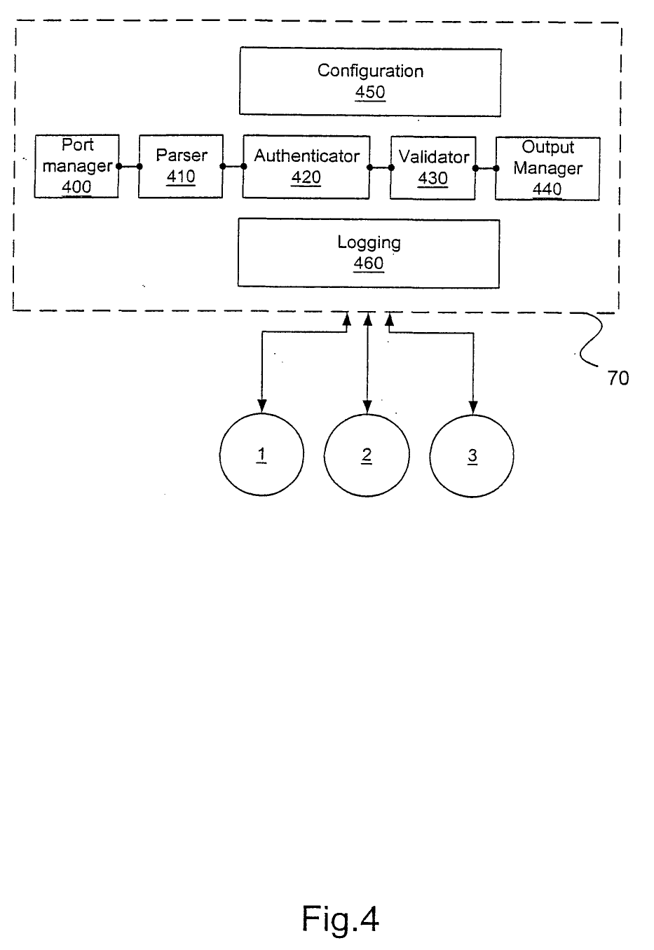

A second embodiment of the present invention assembles a system as showed in FIG. 1, wherein the validation host 70 comprises a port manager 400, as showed in FIG. 4. Further descriptions are to be found below with reference to a functional description of FIG. 4.

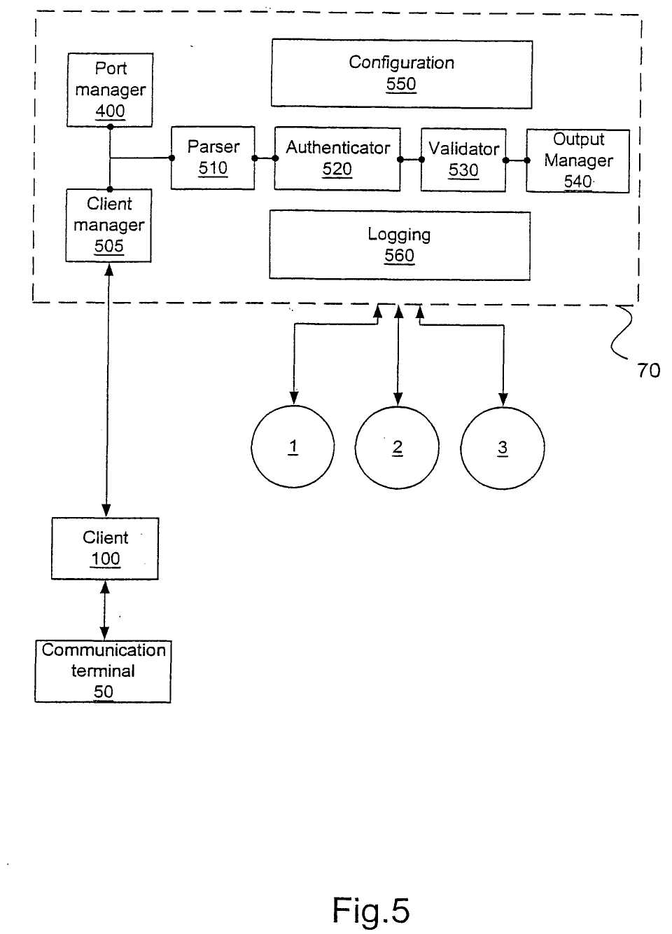

A third embodiment of the present invention assembles a system as showed in FIG. 1, wherein the validation host 70 comprises both the port manager 400 and the client manager 300. Further descriptions are to be found below with reference to a functional description of FIG. 5.

A fourth embodiment of the present invention assembles a system as showed in FIG. 1, wherein the validation host 70 is assembled as in FIG. 3, i.e. the validation in the validator 330 is not performed, the authentication in authenticator 320 is considered sufficient.

A fifth embodiment of the present invention assembles a system as showed in FIG. 1, wherein the validation host 70 is assembled as in FIG. 4, i.e. the validation in the validator 430 is not performed, the authentication in authenticator 420 is considered sufficient.

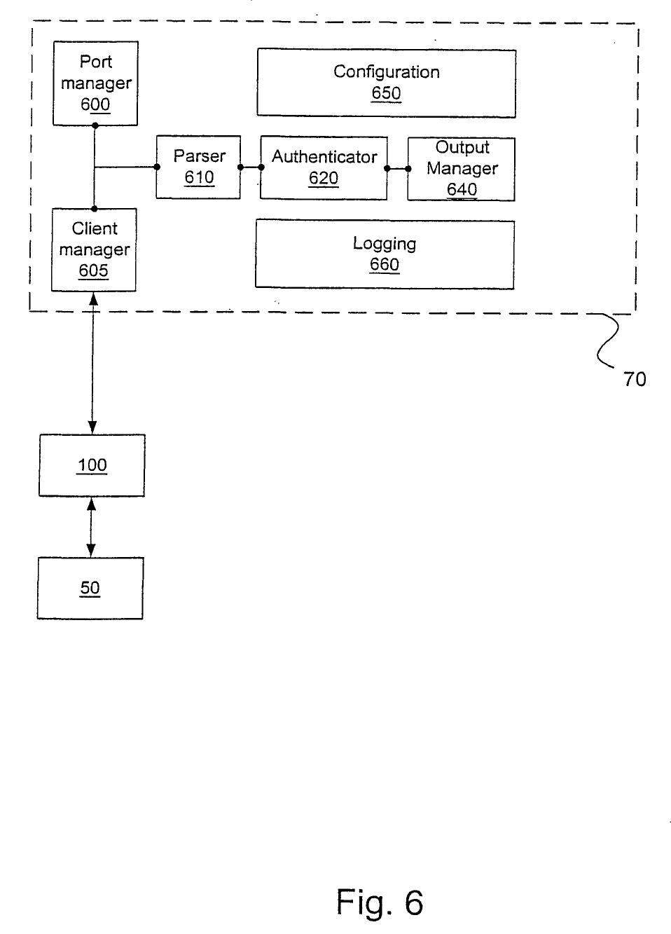

A sixth embodiment of the present invention assembles a system as showed in FIG. 1, wherein the validation host 70 comprises a combination of the fourth and fifth embodiments. Further descriptions are to be found below with reference to a functional description of FIG. 6.

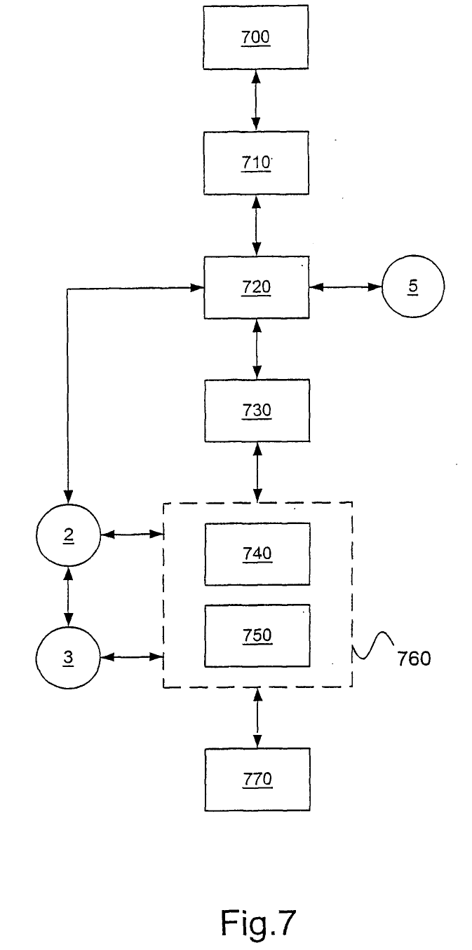

A seventh embodiment comprises a system as showed in FIG. 7, wherein an electronic valuable document generator 710 is connected a distribution server 720, which distributes electronic valuable documents, for example coupons.

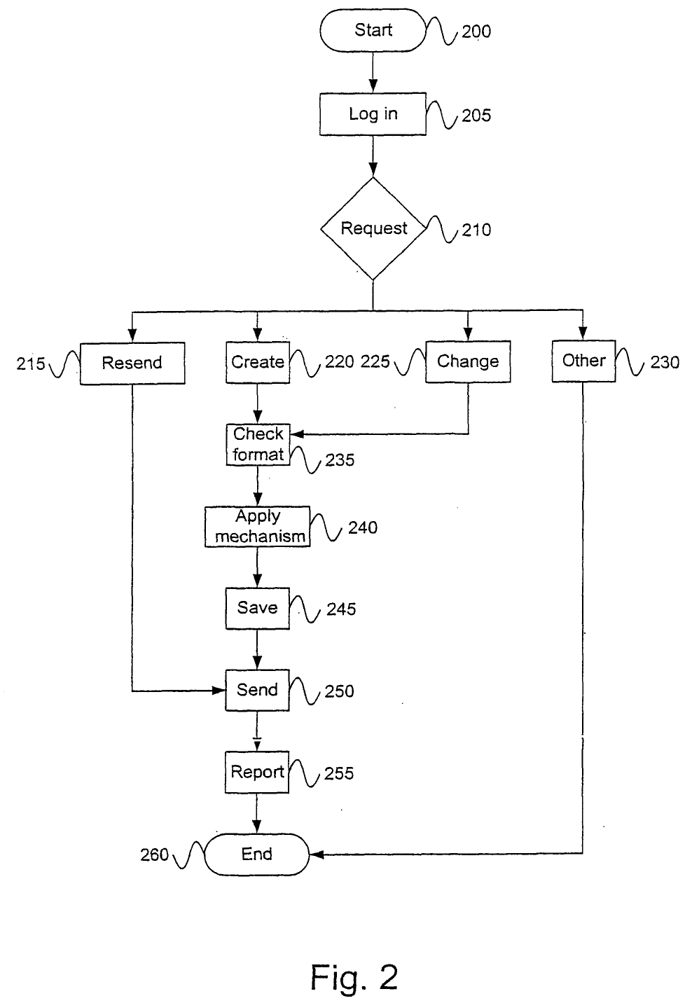

FIG. 2 systematically illustrates a flowchart representing a method for distribution, e.g. flowchart representation of the software in the distribution server 40, shown in FIG. 1. The booking unit 20 can communicate with the distribution server 40 using for example, HTTP-POST, HTTP-GET, Socket, SSL, SMTP or other. In this first version of the system the valuable document is preferably formatted using XML, but other protocols may of course be employed.

After start 200, a first method step log in 205, with registration of the current user, is performed. If registration is completed and approved, the booking unit 20, as shown in FIG. 1, is sending a request 210 to the distribution server 40. There are at least four different options from which the booking unit 20 can choose.

The first option is to create an electronic valuable document 220. Consequently, data is validity checked and formatted 235. If data is approved, one or several mechanisms can be applied 240, for example, encipherment, digital signature, access control, data integrity, authentication exchange, notarisation, or other.

Encipherment fulfils the service confidentiality and partly authentication and integrity. This can be performed with either a symmetric (the same key is used for both coding and decoding) or asymmetric (different keys are used) algorithm. Further, the algorithm can be either a block cipher or a stream cipher depending on how it acts on the message.

The preferred mechanism in the present invention is digital signature. The term refers to an encrypted check-sum of an electronic document or message. Each issuer of signatures has a unique pair of keys from which one is private and the other is public. The public key is available for anyone who needs to verify the signature. The private key is used for signing, and the public key is used for verification of the signatures created by the private key.

Access control implies a connection between the identity of a subject and one or several authorities, i.e. powers and competencies to objects or events. The first step in an access control is to verify the purchaser's identity. Significant for this mechanism is an access control database with information about the purchaser.

The mechanism data integrity, guarantees the receiver that transmitted data is neither intentionally nor non-intentionally changed during the transmission, and is based upon a checksum calculation or a cryptographic control value.

Authentication exchange is a mechanism for either one or two way verification of the counter-part's identity. In the simplest case, this can be performed with passwords.

Notarisation means that transmission attribute information is entrusted to a third part, for later verification.

A copy of the message is then saved (in step 245) in persistent storage, for example in the second database 2 which can be synchronised with the third database 3 to keep them consistent. The message is thereafter sent 250 to the communication terminal 50 in FIG. 1 and a report is sent 255 to the booking unit 30 which reports consist of results and status of distribution request. The routine ends at step 260.

The second request option is to re-send, in step 215, an already existing mobile electronic value document. The procedure precedes step 250, 255 and 260.

The third request option is to change, in step 225, one or more parameters in an already existing mobile electronic value document. Thereafter the steps 235-260 are performed.

The fourth request option is any other 230 option, such as, statistics and/or status information etc. One or more steps between the steps 215 and 265 may be performed.

FIG. 3 illustrates a block representation of the software in the validation host 70 in FIG. 1. A first embodiment comprises the following: A client manager 300, followed by a parser 310 and an authenticator 320. Furthermore, a validator 330 and an output manager 340. The validation host 70 also comprises configuration methods 350 and logging routines 360.

Consider the first embodiment of the present invention where a user, by following procedures shown in FIG. 1, e.g. interacting with the booking unit 20, receives an electronic valuable document through the distribution server 40. The user has to pass through the sequence of validation to get access to an event.

This first embodiment concerns situations in which it is of major importance to be able to upgrade and exchange software in a convenient, fast and cost effective manner. This embodiment with clients handled by a central server meets such requirements, not the least for maintenance and service reasons. The central server may be for instance an ordinary stationary PC or a portable pocket PC, with a plurality of associated clients 100. By using a number of communication terminals (50) for communication with the clients 100 as shown in FIG. 3, for example PDAs that communicate directly with the client manager 300, located in the validation host 70 in the validation unit 80, shown in FIG. 1, the object of enabling flexible software upgrades and convenient maintenance of the system is fulfilled.

At the time for validation the user seeks out a client 100 which can communicate with the validation unit 80. The client 100 comprises a port manager, which extracts the messages from the user's communication terminal 50 and sends it to a validation unit 80 for validation. The communication between the client 100 and the user's communication terminal 50 is preferably executed by using infrared (IR) technology or radio frequency (RF) technology i.e. Bluetooth, however, other methods for access may evolve freely within the general field of access technologies. The communication between the client 100 and the validation unit 80 is preferable carried out using wireless local area networks (WLANs).

The extracted messages are handled and processed in the validation unit 80, as described below, and a response is sent back from the validation unit 80 to the client 100. The response includes one of the following; first, status information of electronic valuable documents. An example of this is whether the electronic valuable documents already have been validated or used. Secondly, the response announces in case no electronic valuable documents were found and third, any other error code or information.

It can easily be understood that this preferred embodiment of the invention gathers the intelligence to a limited number of validation units 80, often a single one is sufficient. Also, that the flexible clients may contribute to a fast and efficient validation at, for example, a sport event which takes place in a big stadium with many entrances at different locations.

The client manager 300 manages the network communication between the client 100 and the validation unit 80. Client manager 300 is de facto a server and reads messages from the validation client. The messages could for example have SMS, EMS or MMS as their carrier.

Messages are translated to an internal data format, (in the SMS case, from PDU), in the parser 310. Messages written in a not suitable or desired format are filtered off and remaining messages are compared with a template. Further, controls of date, time, and sundries are effected.

In authenticator 320 an authentication of the messages is carried out. Depending on which mechanisms that were applied in step 240, refer to FIG. 2, this is performed in different ways.

The next step is to validate the electronic valuable documents. This is accomplished by verification towards anyone of the first, second and third databases 1, 2, and 3, respectively, and is carried out of the validator 330. Carriers used at present are for example TCP/IP Sockets, Http, Serial, and SQL, other may of course be used in the future.

After validation, the results are sent back to the client 100, as earlier mentioned, and in some cases managed by an output manager 340. The results might be presented or applicable to various forms of outputs in the output 90, shown in FIG. 1. For example, monitors, graphical user interface (GUI), gates, turnstiles, printers, touch screens etc. In this first embodiment the output manager 340 can be tailored, i.e. individually adapted, to the actual infrastructure of the vendor.

A practical functionality of, for example this embodiment, is that a step wise countdown may be applied, for example by simply count down the value of the electronic valuable document in the database 2 or the database 3, and via the distribution server 40, wherein it is processed, forward the same electronic valuable document but with a lower value back to the communication terminal 50.

FIG. 4 illustrates a second embodiment of the present invention. The great difference between this and the preferred embodiment is that the port manager in the client 100 here is in the validation host 70, as shown.

The port manager 400 controls the communication between the communication terminal and the communication terminal 50 in the same way as when the port manager in the client 100 controls the communication with communication terminal 50 in the first embodiment. After the messages are extracted from the communication terminal 50 they passes the parser 410, authenticator 420, validator 430, output manager 440, configuration 450, and logging 460 in corresponding way as described in the first embodiment. The parts 310, 320, 330, 340, 350 and 360, works as corresponding parts in FIG. 4, respectively, as shown in FIG. 3.

FIG. 5 illustrates a third embodiment in accordance with the present invention, wherein the validator 330 in the first embodiment (FIG. 3), and the validator 430 in the second embodiment (FIG. 4) are excluded. In other words, no validation as described for validator 330 and validator 430 is performed. Obviously, there are no connections to the databases 1, 2 and 3.

The third embodiment represents a version of the system and a method where fast, smooth and simple access to an event is of prior concern. Since no validation against any databases is performed, i.e. no delays in this phase, an effective alternative is given.

There are at least three versions of this embodiment; it can be embodied in either the client version, in which a client 100 extracts messages as described in the first embodiment; or as described in the second embodiment; or as a combination of the first and second embodiments. The three mentioned versions are a fourth, fifth, and sixth embodiment, respectively.

FIG. 6 illustrates a block representation of the software in the validation host 70 in FIG. 1. This sixth embodiment comprises the following: A port manager 600, a client manager 605, followed by a parser 610 and an authenticator 320, further an output manager 640. The validation host 70 also comprises configuration methods 650 and logging routines 60.

The fourth, fifth, and sixth embodiments are versions of the first, second, and third embodiments, respectively. The only difference is that the validator not is used, i.e. the authentication in any authenticator is considered sufficient.

FIG. 7 illustrates a seventh embodiment in accordance with the present invention, in which a user interface 700 may communicate with an electronic valuable document generator 710. The electronic valuable document generator 710 comprises a CRM, or a Web administrator, and communicates with a distribution server 720. Further, the distribution server 720 is connected to a product catalogue 5, i.e. a database, and the second database 2. Furthermore, the distribution server 720 communicates with a communication terminal 730, in the same manner as described for the communication between distribution server 40 and the communication terminal 50 in FIG. 1. As well as described in FIG. 1, the communication between the communication terminal 730 and a validation unit 760, comprising of a hardware device 740 and a validation host 750, may be performed preferable with IR-technology, RF-technology or other, such as manual registration. The validation unit 760 is connected to the third database 3, which further is connected to the second database 2. The validation unit also is connected directly to the second database 2. Further, the validation unit 760 communicates with output means 770.

The user (who can be an issuer in a first phase, any user in a second phase) uses the user interface 700, which may consists of a WAP-browser, Web-browser, CTI, call centre, or other, to communicate with the issuer's CRM-system.

The web administrator is appropriate when there is no CRM-system, or as a first step for a company that wants to adopt this embodiment, before it eventually starts using a CRM-system. Anyhow, a value document containing essential information is sent, either from the CRM-system or the Web administrator, to the distribution server 720.

The distribution server 720 works in general as the distribution server 40, shown in FIG. 1, with the additional functionally relating to the connection with the product catalogue 5. In the product catalogue 5 information about the vendor's products and services is stored. Each issuer can choose which vendors they want to support. The distribution server 720 distributes the value document to the communication terminal 730 accordingly to what is described in the detailed description of FIG. 2. A copy of the value document and additional relevant information is stored in the second database 2. The copy and the information may be sent to the third database 3.

Likewise as in the previously described the first, second, and third embodiments, the electronic value documents in the communication terminal 730 are extracted by a port manager in the validation host, or by the port manager in the client 100. The validation unit 760 works as the validation unit 80, showed in FIG. 1. The validation is performed towards the third database 3 and/or the second database 2. The third database 3 may be synchronised with the second database 2. As in other embodiments, information may be stored and statistics may be collected. The validation unit 760 can be connected to the vendor's retail system.

If appropriate, the output from validation host 750 may be presented in the output means 770. The output means 770 comprises, like in the other embodiments, for example GUI's.

Essentially this embodiment constitutes a particular system and a method for distribution and validation of mobile electronic value documents, i.e. mobile electronic coupons.

Issuers may use this invention as a reward system for their customers. Issuers may be a variety of actors, for instance; companies with loyalty programs, companies with customer service, companies within the market research area, companies that adjust prices of various items, companies that want to give known or unknown customers value documents, for example coupons, based on their location/positions or connected to an activity. The value document can be redeemed at companies in possession of a validation unit 760 and are involved.

A few examples of feasible vendors for flexible and dynamic pricing of items utilising the present invention may be; cinemas, record stores, flower stores, hotels, cloths stores, car rental companies, travel companies, etc. In some cases a company acts as both issuer and vendor.

Hereby follow three examples of applications of the seventh embodiment.

A customer that has earned loyalty points orders an electronic coupon, in this case a cinema ticket. The customer receives the value document and brings the mobile phone to the cinema. At the cinema the value document is redeemed and validated.

A customer has bought a product or service that has not met his expectations and he/she has complaint to the company's customer service. In the dialog between the customer and the customer service, the customer is offered a coupon valid at a flower store. At the flower store the coupon is redeemed and validated.

A customer has played on a lottery. The lottery contained a large monetary price and many comfort prices. As comfort prices the company used electronic coupons that are valid at a major international hotel chain. At the hotel the coupons are redeemed and validated.

1. A trade system for automated transfer of valuable documents between a user and a vendor, comprising a user interface (10) that communicates with a booking unit (20), the system further comprising;
a distribution server (40) adapted to create and distribute valuable documents from said distribution server (40) to a mobile communication terminal (50);
a payment service (30) for administration of payments for transferred valuable documents, both the distribution server (40) and the payment service (30) being associated with the booking unit (20);
the mobile communication terminal (50) being adapted in particular for communication with the distribution server (40) by means of anyone of current message carrier means;
at least one persistent memory location (1, 2, 3), accessible from the booking unit (20), and/or the distribution server (40), being arranged for storage of data relating to the transfer of created valuable documents;
an output means (90,770)
characterised in that
said validation unit (80) is arranged to cooperate with said mobile communication terminal and the output means (90, 770) and with said persistent memory location to control and validate the created valuable document; wherein
the mobile communication terminal (50) transmits the created valuable document to the validation unit (80), the validation unit (80) receives and validates the created valuable document by connection to said persistent memory location (1, 2, 3); and
said validation unit (80), in response to validation of said created valuable document being arranged to cooperate with said output means (90,770) to enable the user to obtain automated trading.

2. A trade system according to claim 1, characterised in that
the mobile communication terminal (50) is a mobile unit, such as a mobile telephone, personal digital assistant (PDA), a pager or any other kind of electronic communication means

3. A trade system according to claim 1 characterised in that
communication between the distribution server (40) and the communication terminal (50) is accomplished by means of anyone of the following message carriers or notification services: short message service (SMS), multiple message service (MMS), enhanced message service (EMS) or electronic mail.

4. A system according to anyone of claims 1-3, characterised in that
the validation unit (80) is provided with a client manager (300) for handling a plurality of validating clients (100) simultaneously, said clients are servers.

5. A system according to anyone of claims 1-3, characterised in that
the validation unit (80) is provided with a port manager (400) for centralised handling of a plurality of validations of documents.

6. A system according to anyone of claims 1-3, characterised in that
the validation unit (80) is provided with a combination of client manager (300) and port manager (400).

7. A system according to anyone of preceding claims, characterised in that
the communication between the communication terminal (50) and the validation unit (80) is performed by means of radio frequency technology, infrared transmission or another state of the art transmission technology, such as ultrasonic transmission.

8. A method for automated transfer of valuable documents between a user and a vendor, the method comprising the step of:
initialising transfer of documents by a user connecting via the user interface (10) to a booking unit (20);
user interface (10) communicating with the booking unit (20)
sending from the booking unit (20) to a distribution server (40) a request (210) for the valuable document;
receiving in the distribution server (40) from the booking unit (20) said request (210);
creating the valuable document in the distribution server (40) in response to said request (210);
transmitting the created valuable document from the distribution server (40) to a mobile communication terminal (50);
characterised by the steps of:
transmitting the created valuable document from the mobile communication terminal (50) to a validation unit (80);
parsing the created valuable document from notification format or message carrier format to any readable format and validating the created valuable document, both of which steps take place in a validation unit (80); and
transmitting a confirmation message in response to validation of said valuable document, from the validation unit (80) to an output means (90,770) so as to enable the user to obtain trading.

9. A method for automated transfer according to claim 8, further characterised by the step of:
applying at least one security mechanism (245) in order to enable later authentication of the created valuable document.

10. A method for automated transfer according to claim 8 or 9, characterised by
transmitting the confirmation message for acting in response to the valuable document to the client (100) from which the created valuable document originally was sent.

11. A method for automated transfer according to claim 8-10, characterised by
transmitting the confirmation message for acting in response to the valuable document to each of the client (100) and the output means (90) separately and at the same time.

12. A method for automated transfer according to anyone of claims 8-11, further characterised by the steps of:
initialising configuration of the system by means of requesting a validation unit (80) software update from an administrator;
transmitting the validation unit (80) software update from the administrator of the trade system to a vendor; and
configuring the validation unit (80) in response to the initial request for configuration.

13. A method for automated transfer according to anyone of the claim 8-12, further characterised by the steps of:
stepwise counting down a part of the value of the created valuable document, such that the created valuable document is functioning as a coupon.

14. A computer program product for automated transfer of valuable documents, the computer program product being adapted for initialising and carrying out the method steps of anyone of the claims 8-13.
